(19) United States
(12) Patent Application Publication
(10) Pub. No.: US 2026/0070493 A1
(43) Pub. Date: Mar. 12, 2026

(54) VEHICLE WITH DEPLOYABLE UTILITY UNIT

(71) Applicant: International Truck Intellectual Property Company, LLC, Lisle, IL (US)

(72) Inventors: Christopher Schmitt, Naperville, IL (US); Eric Michael Dluzen, Aurora, IL (US)

(73) Assignee: International Truck Intellectual Property Company, LLC, Lisle, IL (US)

(21) Appl. No.: 18/828,565

(22) Filed: Sep. 9, 2024

(51) Int. Cl. B60R 11/00; B60J 5/04; B60N 3/16

(52) U.S. Cl. CPC B60R 11/00; B60J 5/0491; B60N 3/16; B60R 2011/0082

(57) ABSTRACT

A vehicle is provided. In one embodiment, the vehicle includes a vehicle cabin for one or more occupant, and a deployable utility unit housed partially or completely in the vehicle cabin. The deployable utility unit is connected to the vehicle cabin using a support mechanism comprising at least one hinge and at least one utility support arm each attached to the deployable utility unit, wherein the deployable utility unit is advanced from a first position inside the vehicle cabin to a second position exterior to the vehicle cabin by pivoting the deployable utility unit about the at least one hinge through an opening in a vehicle cabin exterior housing.

### FIELD

The present disclosure generally relates to vehicle technologies. More particularly, the present disclosure relates to a vehicle with a deployable utility unit.

### BACKGROUND

Some vehicle operators, such as truck drivers, can spend an appreciable amount of time in their vehicle while on a long-haul trip. For instance, a driver may sometimes sleep or eat in a vehicle to save time or resources. However, some activities carried out inside a vehicle may carry certain risks. For instance, preparing food inside a vehicle may result in fire, may cause unpleasant smells or smoke, or may make cleaning difficult or impossible. Also, cooking equipment may be heavy or bulky, and thereby limit or impede other activities in the vehicle due to a lack of space. Therefore, there is a need for improved vehicle technologies that can improve safety and convenience for drivers.

### SUMMARY

A vehicle is provided. In one embodiment, the vehicle includes a vehicle cabin for one or more occupant, and a deployable utility unit housed partially or completely in the vehicle cabin. The deployable utility unit is connected to the vehicle cabin using a support mechanism comprising at least one hinge and at least one utility support arm each attached to the deployable utility unit, wherein the deployable utility unit is advanced from a first position inside the vehicle cabin to a second position exterior to the vehicle cabin by pivoting the deployable utility unit about the at least one hinge through an opening in a vehicle cabin exterior housing.

In another embodiment, the vehicle includes a vehicle cabin for one or more occupant and a deployable utility unit housed partially or completely in the vehicle cabin. The deployable utility unit is connected to the vehicle cabin using a support mechanism comprising at least one utility support arm attached to the deployable utility unit, wherein the deployable utility unit is advanced from a first position inside the vehicle cabin to a second position exterior to the vehicle cabin by pivoting the at least one utility support arm through an opening in a vehicle cabin exterior housing.

### BRIEF DESCRIPTION OF THE DRAWINGS

The present disclosure describes various embodiments with reference to the accompanying figures, wherein like reference numerals denote like elements. The embodiments described are presented by way of example, and not by way of limitation, in the accompanying drawings:

FIG. 1A is a diagram of an example system, according to embodiments described herein;

FIG. 1B is a side view of an example vehicle, according to embodiments described herein;

FIG. 1C is a front view of the example vehicle in FIG. 1B, according to embodiments described herein;

FIG. 2A is a front view of another example vehicle, according to embodiments described herein;

FIG. 2B is another front view of the example vehicle of FIG. 2A, according to embodiments described herein;

FIG. 3A is an illustration of an example utility support system in operation, according to embodiments described herein;

FIG. 3B is another illustration of the example utility support system of FIG. 3A, according to embodiments described herein;

FIG. 3C is yet another illustration of the example utility support system of FIG. 3A, according to embodiments described herein;

FIG. 3D is an illustration of another example utility support system in operation, according to embodiments described herein;

FIG. 3E is an illustration of yet another example utility support system in operation, according to embodiments described herein;

FIG. 4A is a front view of another example vehicle, according to embodiments described herein;

FIG. 4B is another front view of the example vehicle of FIG. 4A, according to embodiments described herein;

FIG. 5A is an illustration of yet another example utility support system in operation, according to embodiments described herein;

FIG. 5B is another illustration of the example utility support system of FIG. 5A, according to embodiments described herein;

FIG. 5C is yet another illustration of the example utility support system of FIG. 5A, according to embodiments described herein;

FIG. 6A is an illustration of yet another example utility support system in operation, according to embodiments described herein;

FIG. 6B is another illustration of the example utility support system of FIG. 6A, according to embodiments described herein;

FIG. 6C is yet another illustration of the example utility support system of FIG. 6A, according to embodiments described herein; and

FIG. 7 is a flowchart setting forth steps of a process, according to embodiments herein;

### DETAILED DESCRIPTION

Due to safety, space, cost, and other considerations, an activity carried out in or around a vehicle may raise a number of issues. For example, various approaches, such as using a hot plate, crock pot, portable grill, or installing an aftermarket kitchen, may be used prepare food inside a vehicle. Yet such conventional technologies present a number of risks and disadvantages, such as fire, smoke, difficulty cleaning, and so forth.

By contrast, the present disclosure provides a technical solution that overcomes shortcomings and provides improvements over current vehicle technologies. For instance, as appreciated from embodiments described below, the present approach may help reduce a risk of fire by providing a vehicle with a deployable utility unit that can be positioned and operated outside of a vehicle cabin. Also, a deployable utility unit, in accordance with embodiments described herein, may also free up space, reduce air contamination inside a vehicle, provide a convenient access point and/or emergency exit, aid in loading and unloading, and so forth. In addition, equipment in a deployable utility unit operable exterior to a vehicle may be cleaned using a hose or other cleaning device or chemical, which may be prohibited or difficult inside the vehicle. Moreover, a deployable utility unit integrated in a vehicle, in accordance with embodiments described herein, may help ensure usage of appropriate equipment and in a manner intended.

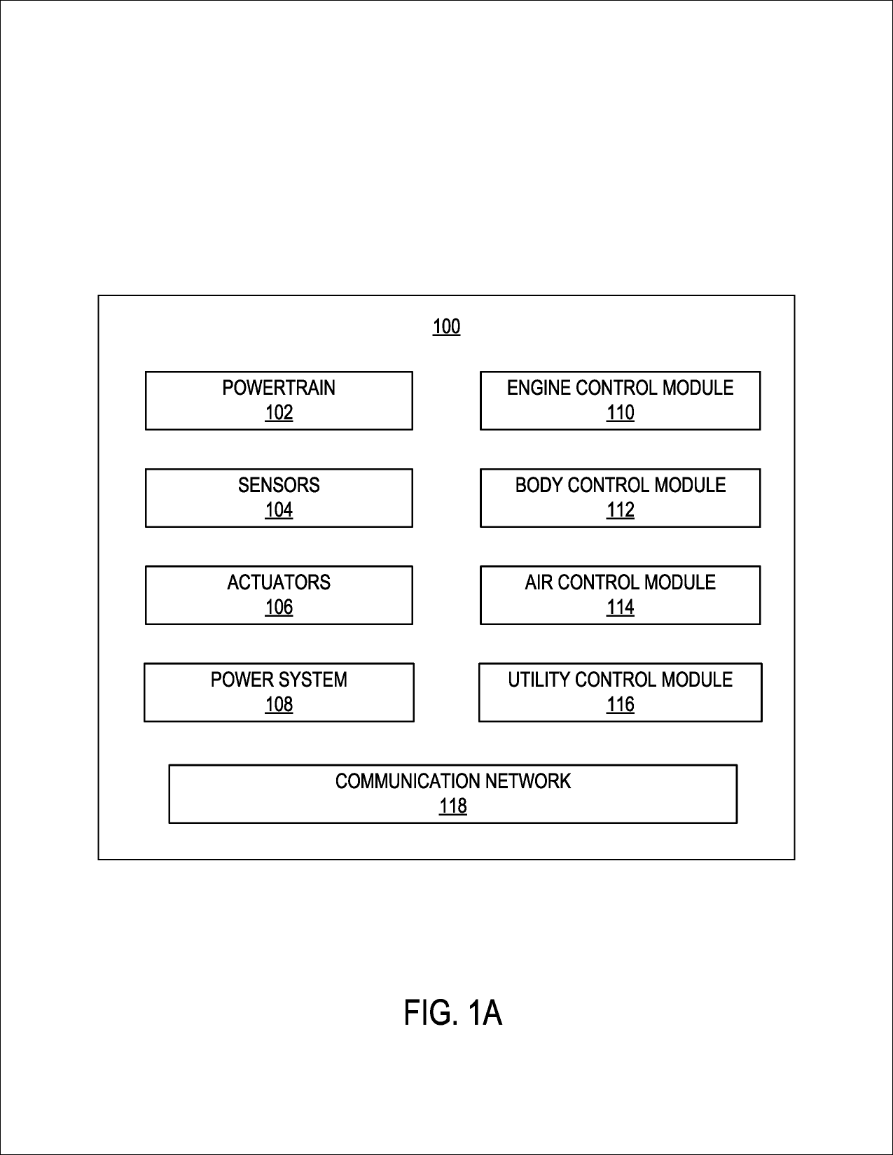

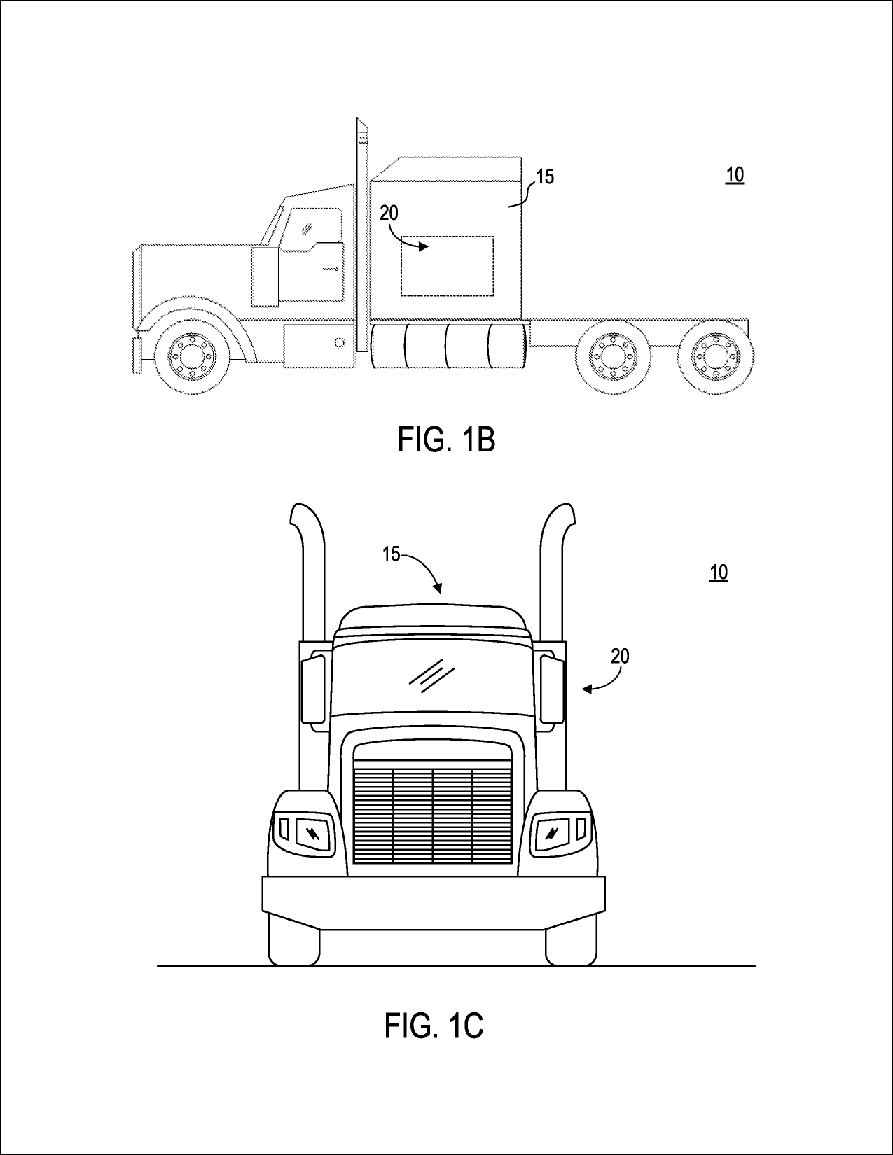

Turning to FIGS. 1A-1C, an example vehicle 10 is illustrated, in accordance with aspects of the present disclosure. Among various components, systems, compartments, and features, the vehicle 10 may include a vehicle cabin 15, where one or more occupant (e.g., a driver, a passenger, and so forth) may perform various activities, such as driving, sleeping, eating, and so forth. As shown in FIGS. 1B-1C, the vehicle 10 may also include a deployable utility unit 20.

The deployable utility unit 20 may be partially or completely housed inside the vehicle cabin 15. The deployable utility unit 20 may include various components, attachments, fasteners, mechanisms, and/or other features that may be used to hold the deployable utility unit 20 partially or completely inside the vehicle cabin 15, to advance or deploy the deployable utility unit 20 from the vehicle cabin 15 to an exterior position, to secure the deployable utility unit 20 in the exterior position, and/or to retract or stow the deployable utility unit 20. In some embodiments, the deployable utility unit 20 includes a deployable kitchen unit. In some embodiments, the deployable utility unit 20 includes a container, crate, tub, or other component for holding, storing, and/or securing various items or objects, such as luggage, tools, cooking equipment and so forth. In some embodiments, the deployable utility unit 20 may include a locking mechanism, a safety feature, and so forth, that may be activated or engaged to secure the deployable utility unit 20 in place.

The deployable utility unit 20 may be connected to the vehicle cabin 15 using a utility support system (not shown in FIGS. 1A-1C). The utility support system may include various components, attachments, fasteners, mechanisms, and/or other features that may be used alone, or in combination with various components, attachments, fasteners and/or other features on the deployable utility unit 20, to hold the deployable utility unit 20 partially or completely inside the vehicle cabin 15, to advance or deploy the deployable utility unit 20 from the vehicle cabin 15 to an exterior position, to secure the deployable utility unit 20 in the exterior position, and/or to retract or stow the deployable utility unit 20.

For instance, in some embodiments, the support mechanism may include one or more hinge attached or attachable, either directly or indirectly, to the deployable utility unit 20. In some applications, the deployable utility unit 20 may be positioned exterior to the vehicle cabin 15 by pivoting the deployable utility unit 20 about one or more hinge attached to both the vehicle cabin 15 and the deployable utility unit 20. By way of example, the hinge(s) may include a butt hinge, ball bearing hinge, spring-loaded hinge, barrel hinge, T-hinge, concealed hinge, overlay hinge, butterfly hinge, gate hinge, scissor hinge, knuckle hinge, pivot hinge, overlay hinge, offset hinge, strap hinge, and so forth.

In some embodiments, the support mechanism may include one or more support arm attached or attachable, directly or indirectly, to the deployable utility unit 20, or movable relative to the deployable utility unit 20. The support arm(s), or one or more component thereof, may be rigid, flexible, extendible, telescoping, articulating, foldable, windable, adjustable, pneumatic, powered, and so forth. In some applications, the deployable utility unit 20 may be positioned exterior to the vehicle cabin 15 by pivoting the support arm(s) about a point or axis of attachment on the vehicle cab 15. By way of example, the support arm(s) may include a rod, cable, spring, chain, telescoping arm, link, jib, crane, cylinder, and so forth.

Referring again to FIG. 1A, in some embodiments, the vehicle 10 may include a system 100. In general, the system 100 may include a vehicle powertrain 102, one or more sensor 104, one or more actuator 106, and a power system 108. The powertrain 104 may include a variety of components, including an engine, transmission, driveshaft, axle, differential, and so forth, that together create power and deliver it to wheels of the vehicle 10 to propel the vehicle 10. In some applications, the vehicle 10 is powered by an internal combustion engine. In other applications, the vehicle 10 is powered by electric power provided by one or more electric motors. In yet other applications, the vehicle 10 is powered by a combination of electric and combustion power.

The sensor(s) 104 may include various sensors or sensing devices that can provide data, signals, and information about the vehicle 10 and/or vehicle operation. In some non-limiting examples, the sensor(s) 104 may include one or more steering angle sensor, yaw rate sensor, brake pressure sensor, grade sensor, inclinometer sensor, wheel sensor, speed sensor, cruise control sensor, transmission gear sensor, load sensor, fuel sensor, airflow sensor, coolant sensor, sparkplug sensor, throttle sensor, oxygen sensor, temperature sensor, pressure sensor, voltage sensor, current sensor, and so forth. In some embodiments, the sensor(s) 104 may include one or more sensor and/or one or more sensing device that can indicate a status or position of the deployable utility unit 20, or component thereof.

The actuator(s) 106 may include various hardware that can perform various tasks on the vehicle 10, including regulating fluid flow, moving or energizing components, controlling valves or relays, activating switches, operating gears or motors, and so forth, by way of mechanical, hydraulic, pneumatic, magnetic or electrical activation, or movement of components. The actuator(s) 106 may control various hardware and components on the vehicle 10, such as a fan, heat exchanger, heater, valve, pump, gear, switch, winch, motor, electrical circuit or component, and so forth. In some embodiments, one or more actuator 106 may control a position of a deployable utility unit 20, or one or more component thereof.

The power system 108 may include a variety of hardware and components, including one or more batteries, solar panels, starters, alternators, relays, converters, controllers, regulators, switches, solenoids, electrical wiring, electrical circuitry, electrical elements, and so forth. In some embodiments, the power system 108 provides power to one or more sensor 104 and/or one or more actuator 106 on the vehicle 10 to determine and/or control a position of a deployable utility unit 20, or one or more component thereof.

Referring again to FIG. 1A, the system 100 may also include a number of control modules that perform, manage and monitor various functions of the vehicle 10. For instance, in some embodiments, the system 100 may include an engine control module (ECM) 110, a body control module (BCM) 112, an air control module (ACM) 114, a utility control module 116, as well as others.

The ECM 110 may control various parameters and functions of the engine on the vehicle 10, including the air-fuel ratio, idle speed, valve timing, ignition timing, crankshaft position, and so forth. To this end, the ECM 110 may include any combination of analog and/or digital inputs and outputs, microprocessors, integrated circuitry, memories, clocks, Application Programming Interfaces (APIs), firmware, software, and so forth, and may communicate with various sensors 104, actuators 106, and other component on the vehicle 10.

The BCM 112 may monitor and control various vehicle body, security and convenience functions. For instance, the BCM 112 may manage exterior lighting, interior lighting, car locking, remote entry, remote start, windshield wipers, seat adjustment, tire pressure monitoring, and so forth. To this end, the BCM 112 may include various hardware, such as analog and/or digital inputs and outputs, microprocessors, integrated circuitry, programmable circuitry, clocks, batteries, APIs, and so forth, and may communicate with, monitor, and control various components on the vehicle 10.

The ACM 114 may monitor and control various functions and components associated with air flow in the vehicle 10. For instance, in some embodiments, the ACM 114 may control air intake on the vehicle 10 by operating various air control components, such as a fan, a compressor, a turbo, a valve, and so forth.

The utility control module 116 may monitor and control various functions of the deployable utility unit 20, or one or more component thereof. To this end, the utility control module 116 may include various hardware, such as analog and/or digital inputs and outputs, microprocessors, integrated circuitry, programmable circuitry, clocks, batteries, APIs, and so forth, and may connect and/or communicate with, monitor various components on the vehicle 10. In some embodiments, the utility control module 116 may include a memory or a non-transitory computer-readable storage medium for storing and retrieving data, information, and executable instructions. The utility control module 116 may operate independently, receive input or instructions from an operator, and/or cooperate with various computers, systems, devices, and components on the vehicle 10.

In some embodiments, the utility control module 116 may receive, access, and/or process signals, data, and/or information, for instance, acquired using one or more device, component, or sensor 104 disposed on or about the vehicle 10. The utility control module 116 may then act upon such signals, data, and/or information, to control the deployable utility unit 20, or one or more component thereof. For example, in some embodiments, the utility control module 116 may receive an operator instruction (e.g., via an input element) to deploy or stow a deployable utility unit 20, or one or more component thereof. To this end, the utility control module 116 may generate and transmit various control signals. By way of example, one or more control signal (e.g., in the form of voltage signals, current signals, optical signals, and so forth) may control a solenoid, winch, motor, valve, gear, crank, pulley, relay, switch, air pressure, liquid pressure, gas pressure, power, and so forth. In other embodiments, the utility control module 116 may utilize received, accessed, and/or processed signals, data, and/or information to determine a status or position of the deployable utility unit 20, or of a component thereof.

In some embodiments, the utility control module 116 may generate and provide a report. The report may be in any form, and include various data and information, including various visual and/or audio signals, images, graphics, tabulated information, data, instructions (user-readable or machine-readable), graphs, lists, numbers, text, and so forth. For example, the report may indicate whether a deployable utility unit, or a component thereof, is in a first position (e.g., stowed partially or completely inside the vehicle cabin), in a second position (e.g., deployed external to the vehicle 10), or in an intermediate position between the first position and the second position. The report may also indicate an error, or malfunction in the deployable utility unit, or a component thereof. The report may be communicated by way of a display, touchscreen, navigation system, speaker, and other outputs on the vehicle 10, as well as transmitted to various devices, systems, or third parties.

Components of the system 100 may be operatively coupled, connectable, or connected to one another, and exchange signals, data, and information, by way of a communication network 118. The communication network 118 may include a variety of hardware and components that provide wired and wireless connectivity via various communication protocols. Non-limiting examples of communication protocols include Control Area Network (CAN), Local Interconnect Network (LIN), Flex-Ray, Vehicle Area Network (VAN), Media Oriented System Transport (MOST), Bluetooth^{TM}, Wi-Fi, and so forth. In some embodiments, the communication network 118 may include one or more vehicle buses that interconnect components and hardware in the system 100. The communications network 118 may also include various gateways, bridges, receivers, transmitters, transceivers, antennas, and other components, circuitry and hardware that enable or facilitate communication.

Although specific components are shown and described with reference to FIG. 1A, the system 100 may include more or fewer components, and may also integrate or separate functions, as described. For instance, in some embodiments, the system 100 may include modules for brake control, climate control, transmission control, and so on. Also, in some embodiments, the system 100 may include a number of input/output (I/O) elements, such as one or more button, dial, knob, touchscreen, keyboard, monitor, screen, panel, display, buzzer, speaker, and so forth, that can receive instructions or input from an operator, and provide data, information, instructions, and other outputs to the operator.

While FIGS. 1B-1C, and figures thereafter, show one example vehicle 10 for purposes of illustration, the vehicle 10 may be any type of automobile, truck, trailer tractor, utility vehicle, sport utility vehicle (SUV), recreational vehicle (RV), as well as a boat, plane, drone, train, and other machines for transporting goods and/or people.

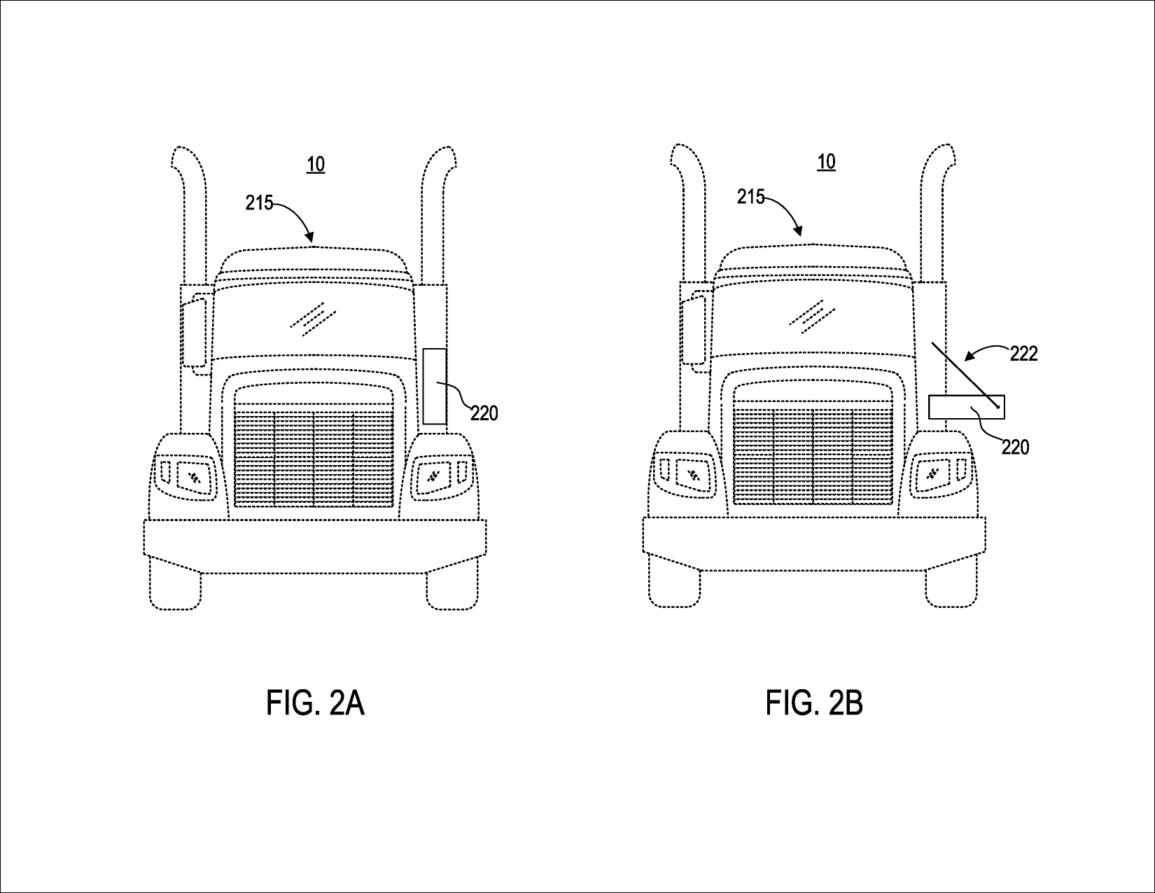

Turning now to FIGS. 2A-2B, an example vehicle 10, in accordance with aspects of the present disclosure, is illustrated. The vehicle 10 may include a vehicle cabin 215 for one or more occupant (e.g., a driver, passenger, and so forth). In some embodiments, the vehicle 10 may include a deployable utility unit 220 partially or completely housed inside the vehicle cabin 215, as shown. The deployable utility unit 220 may be supported and/or operated by a utility support system 222. The utility support system 222 may include various components, attachments, fasteners, mechanisms, and/or other features that may be used, alone or in combination with various components, attachments, fasteners and/or other features on the deployable utility unit 220, to hold the deployable utility unit 220 partially or completely inside the vehicle cabin 215, to advance or deploy the deployable utility unit 220 from the vehicle cabin 215 to an exterior position, to secure the deployable utility unit 220 in the exterior position, and/or to retract or stow the deployable utility unit 220.

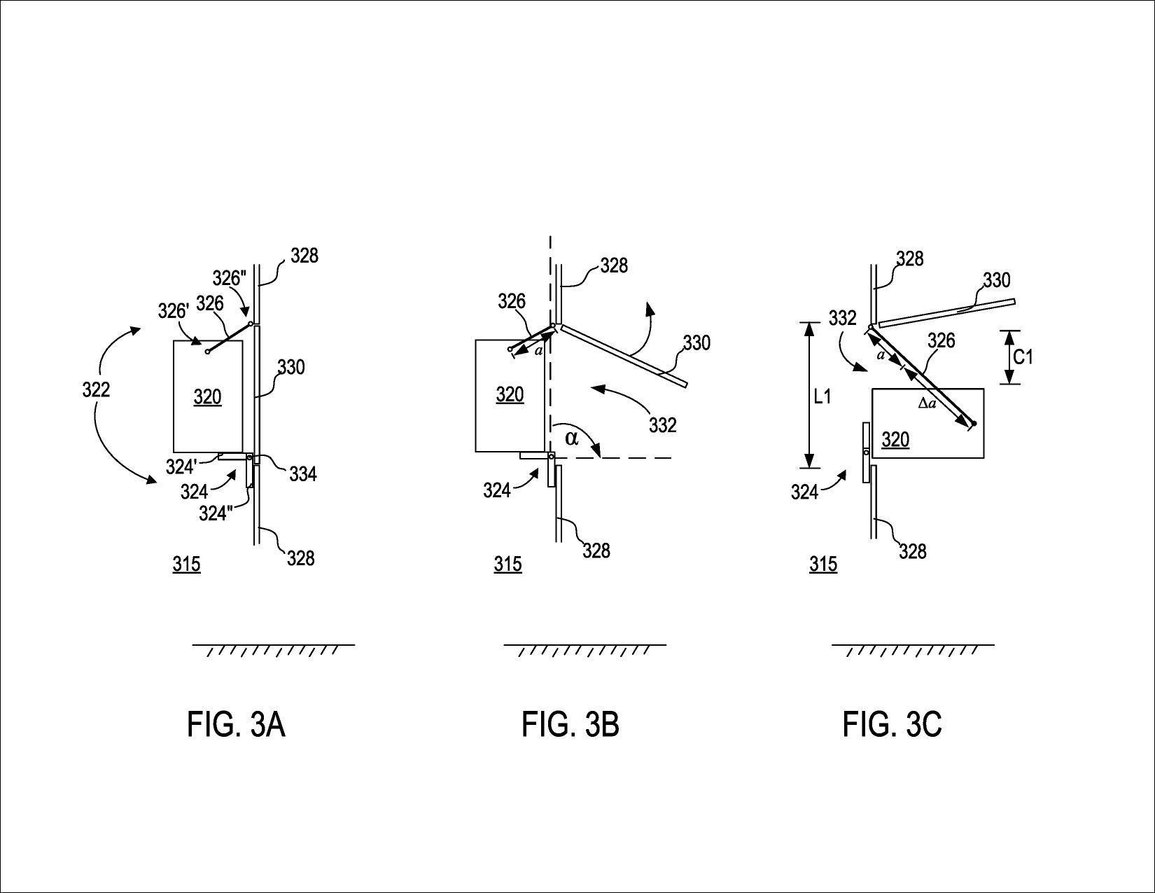

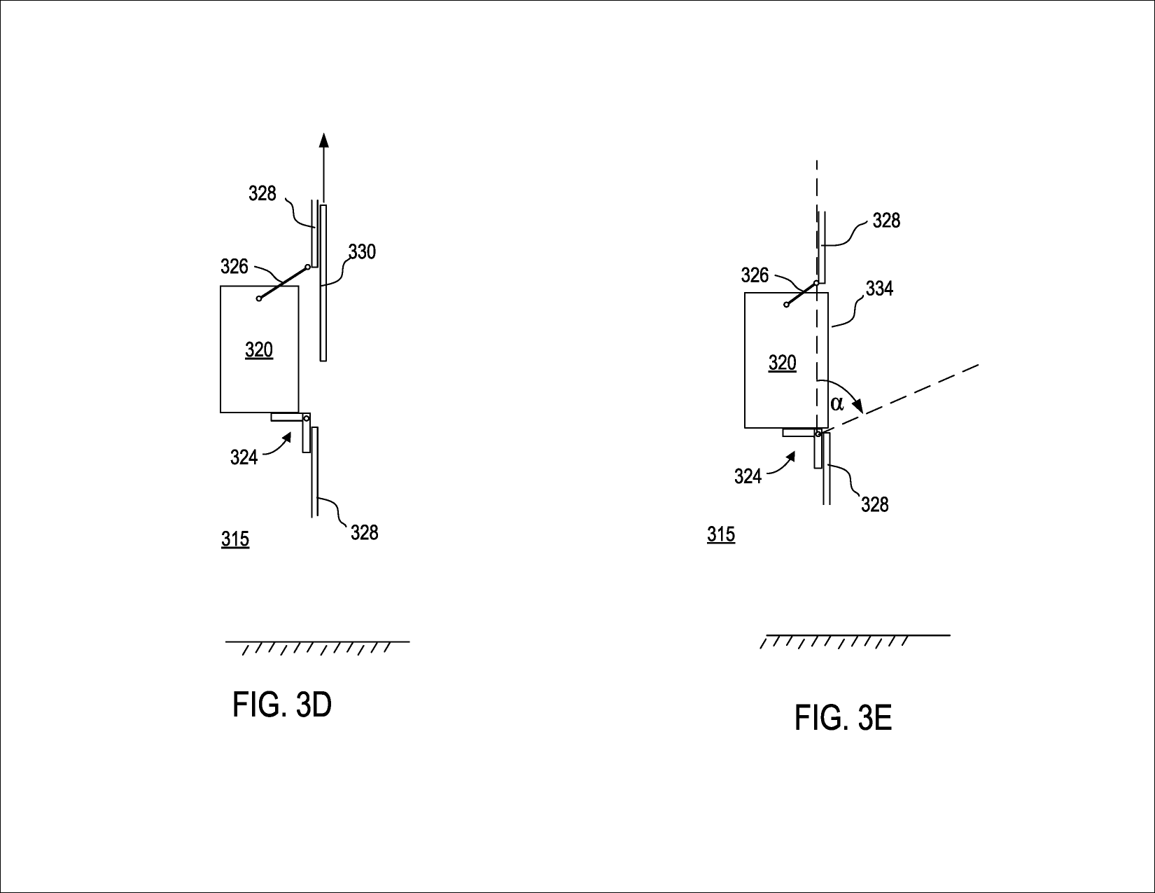

FIGS. 3A-3E illustrate one example of a utility support system 322 operating in cooperation with a deployable utility unit 320 partially or completely housed inside a vehicle cabin 315, in accordance with aspects of the present disclosure. In some embodiments, the utility support system 322 includes a utility hinge 324 and a utility support arm 326. While FIGS. 3A-3E show the utility support system 322 with one utility hinge 324 and one utility support arm 326, it may be appreciated that the utility support system 322 may include more than one utility support arm 326 and/or more than one utility hinge 324.

As shown in FIG. 3A, the utility hinge 324 may be connected or connectable to the deployable utility unit 320 as well as to the vehicle cabin 315. For instance, in some embodiments, a first part 324’ of the utility hinge 324 may be directly attached or attachable (e.g., using one or more fastener, assembly, mechanism, adhesive, and so forth) to a portion or component of the deployable utility unit 320, and a second part 326” of the utility hinge 324 may be directly attached or attachable to a portion or component of the vehicle cabin 315, such as a vehicle cabin interior (not shown) or a vehicle cabin exterior housing 328. In other embodiments, the first part 324’ of the utility hinge 324 may be indirectly attached or attachable to the portion or component of the deployable utility unit 320, for instance, by way of a component or object positioned in between the first part 324’ of the utility hinge 324 and the deployable utility unit 320. Similarly, in some embodiments, the second part 324” of the utility hinge 324 may be indirectly attached or attachable to the portion or component of the vehicle cab 315, for instance, by way of a component or object positioned in between the second part 324” of the utility hinge 324 and the vehicle cabin interior or the vehicle cabin exterior housing 328.

The utility support arm 326 may be connected or connectable to the deployable utility unit 320, as well as to the vehicle cabin 315, as shown in FIG. 3A. For instance, in some embodiments, a first end 326’ of the utility support arm 326 may be directly attached or attachable to a portion or component of the deployable utility unit 320, and a second end 326” of the utility support arm 326 may be directly attached or attachable to a portion or component of the vehicle cabin 315, such as a vehicle cabin interior (not shown) or a vehicle cabin exterior housing 328. In some embodiments, the utility support arm 326 may be connected to the deployable utility unit 320 at the first end 326’ using a fastener, assembly, and/or mechanism that allows rotation of the utility support arm 326 relative to the deployable utility unit 320, as shown in FIGS. 3A-3C. In some embodiments, the utility support arm 326 may be connected to the vehicle cabin 315, or portion or component of the vehicle cabin 315, at the second end 326” using a fastener, assembly, and/or mechanism that allows rotation of the utility support arm 326 relative to the vehicle cabin 315, or portion or component of the vehicle cabin 315.

In some embodiments, the first end 326’ of the utility support arm 326 may be indirectly attached or attachable to the portion or component of the deployable utility unit 320, for instance, by way of a component or object positioned, and attached or attachable, in between the first end 326’ of the utility support arm 326 and the deployable utility unit 320. In some embodiments, the second end 326” of the utility support arm 324 may be indirectly attached or attachable to the portion or component of the vehicle cab 315, for instance, by way of a component or object positioned, and attached or attachable, in between the second end 326” of the utility support arm 326 and the vehicle cabin interior or the vehicle cabin exterior housing 328.

As illustrated in FIGS. 3B-3C, the deployable utility unit 320 may be positioned exterior to the vehicle cabin 315 by operating a movable panel 330 covering an opening 332 in the vehicle cabin exterior housing 328. The movable panel 330 may cover the opening 332 in a manner sufficient or suitable to protect the vehicle cabin 315 interior from exterior elements, as well as risk to any object and/or occupant present in the vehicle cabin 315 interior during vehicle operation. For instance, in some embodiments, the movable panel 330, or a portion thereof, may make close contact (e.g., less than 10 mm) and/or seal to the vehicle cabin exterior housing 328 by virtue of, for instance, a sealing layer or strip. For example, the sealing layer or strip may be affixed to, on, or about a periphery of the movable panel 330 and/or along a periphery of the opening 332 in the vehicle cabin exterior housing 328.

In some embodiments, the movable panel 330 may be connected to and rotated about, for example, a panel hinge to uncover the opening 332 in the vehicle cabin exterior housing 328. The deployable utility unit 320 may then be advanced through the opening 332 by pivoting about a hinge point or hinge axis 334 of the utility hinge 324. As shown in FIG. 3B, in some embodiments, the deployable utility unit 320 may rotate over an angle α relative to a vertical axis, where the angle α of rotation may be in a range between approximately 0 and 135 degrees, although other values may be possible. In one non-limiting example, illustrated in FIGS. 3A-3C, the deployable utility unit 320 may be rotated from a first, or stowed, position, corresponding to an angle α of approximately 0 degrees to a second, or deployed, position corresponding to an angle α of approximately 90 degrees, or more.

The opening 332 in the vehicle cabin exterior housing 328 may have any shape and dimension suitable for allowing the deployable utility unit 320 to be advanced and retracted. In some embodiments, as illustrated in FIG. 3C, a vertical dimension L1 of the opening 332 may be such that upon advancement of the deployable utility unit 320 to a second, or deployed, position, a vertical clearance C1 would remain. In some applications, the vertical clearance C1 may provide an additional access point to an interior of the vehicle cabin 315.

The utility support arm 326 connected to the deployable utility unit 320 may be rigid, flexible, extendible, telescoping, articulating, actuating, foldable, windable, adjustable, pneumatic, powered, and so forth. As such, the utility support arm 326, or a component thereof, may extend, telescope, fold, wind or unwind, articulate, actuate, adjust, pressurize, power, and so forth. For example, as illustrated in FIGS. 3A-3C, the utility support arm 326 may move by pivoting about a point or axis of attachment on the vehicle cab 315 (e.g., on the vehicle cabin interior or vehicle cabin exterior housing 328) at the second end 326” of the utility support arm 326. Additionally, the utility support arm 326, or a component thereof, may transform in shape and/or configuration with movement of the deployable utility unit 320. For instance, the utility support arm 326 may transform in shape by expanding from a length a to a length a+Δa, as illustrated in FIG. 3C.

In one non-limiting example, the utility support arm 326 may include a spring that may expand or contract subject to mechanical force applied thereto. In another non-limiting example, the utility support arm 326 may include a telescoping arm that may expand or contract subject to mechanical and/or other force subject thereto. In yet another non-limiting example, the utility arm 326 may include cylinder and piston assembly that may expand or contract subject to air, gas, or liquid pressure applied to the cylinder and/or piston. In yet another non-limiting example, the utility support arm 326 may include a cable that may expand or contract subject to mechanical force applied thereto. In yet another non-limiting example, the utility support arm 326 may include a cable that may wind or unwind subject to mechanical, electrical, magnetic, or other force applied, for instance, to a gear, wench, or other component or mechanism.

In some embodiments, the deployable utility unit 320 may be positioned exterior to the vehicle cabin 315 by moving the movable panel 330 of the vehicle cabin exterior housing 328 along one or more directions. For example, as illustrated in FIG. 3D, the movable panel 330 may be pushed, pulled, and/or actuated upward, as well as downward, outward, and/or to one side relative to the vehicle cabin 315. In other embodiments, the movable panel 330 may be detached from the vehicle cab exterior housing 328, for instance, by way of a quick release, or other fastener, assembly, or mechanism. The movable panel 330 may also be operable while the deployable utility unit 320 is deployed or in use. For instance, in some implementations, the movable panel 330 may be repositioned or reattached to cover the opening 332 in the vehicle cabin exterior housing 328 when the deployable utility unit 320 is in the second, deployed, position exterior to the vehicle cabin 315. The movable panel 330, or a portion thereof, may make close contact (e.g., less than 10 mm) and/or seal to the vehicle cabin exterior housing 328 while the deployable utility unit 320 is deployed, for example, by virtue of a sealing layer or strip, as described. In this manner, the vehicle cabin 315 interior may be protected from exterior elements or other undesirable exposure (e.g., fumes, smoke from cooking, overspray from cleaning, etc.), as well as other risks, as described.

In some embodiments, the deployable utility unit 320 may serve a protective function similar to the movable panel 330, and as such replace the movable panel 330. For instance, as illustrated in FIG. 3E, an outer surface 334 associated with a portion or component of the deployable utility unit 320 may correspond substantially in shape and dimension with the opening 332. When the deployable utility unit 320 is in a first position (e.g., stowed partially or completely inside the vehicle cabin 315), the outer surface 334 associated with a portion or component of the deployable utility unit 320 may cover the opening 332 in the vehicle cabin exterior housing 328 in a manner sufficient or suitable to protect the vehicle cabin 315 interior from exterior elements as well as risk to any object and/or occupant present in the vehicle cabin 315 interior during vehicle operation. For example, the outer surface 334 may be configured to make close contact (e.g., less than 10 mm) and/or seal to the vehicle cabin exterior housing 328 by virtue of, for example, a sealing layer or strip affixed to, on, or about, a periphery of the outer surface 334 and/or the opening 332 of the vehicle cabin exterior housing 328, as described.

FIGS. 3A-3E illustrate one non-limiting example in which a deployable utility unit 320 undergoes deployment by way of rotation. However, not all components, attachments, fasteners, mechanisms, and/or other features of the deployable utility unit 320 may undergo rotation or similar movement. For instance, in some embodiments, the deployable utility unit 320 may include a container, crate, tub, or other component for holding, storing, and/or securing one or more item or object, such as cooking equipment, luggage, tools, and so forth. In such embodiments, the container, crate, tub, or other component may undergo rotation, as described, yet one or more item or object held, stored, and/or secured therein need not. For example, a tank, grill, or stove may retain orientation (e.g., in a vertical position) while the container, crate, tub, or other component advances exterior to the vehicle cabin 315. To this end, the deployable utility unit 320 may include various components, mechanisms, or features that would allow one or more item or object therein to retain orientation during deployment, for instance.

The deployable utility unit 320, the utility support arm 326, and/or movable panel 330 may be operated manually and/or with the assistance of various mechanisms, actuators, and so forth. For instance, various movements and functions of the deployable utility unit 320, the utility support arm 326, and/or movable panel 330 may be controlled in whole or in part using a utility control module 116, as described with reference to FIG. 1A.

In some embodiments, the deployable utility unit 320 may be detached from the utility support system 322 upon deployment. For instance, the deployable utility 320 may be advanced to the second, deployed, position and then detached from the utility support system 322, thereby allowing transportation and/or use beyond proximity to the vehicle cabin 315. For example, the deployable utility unit 320 may be detached from the first end 326’ of the utility support arm 326 and from the first part 324’ of the utility hinge 324 by way of a quick release, as well as other fastener, assembly, or mechanism.

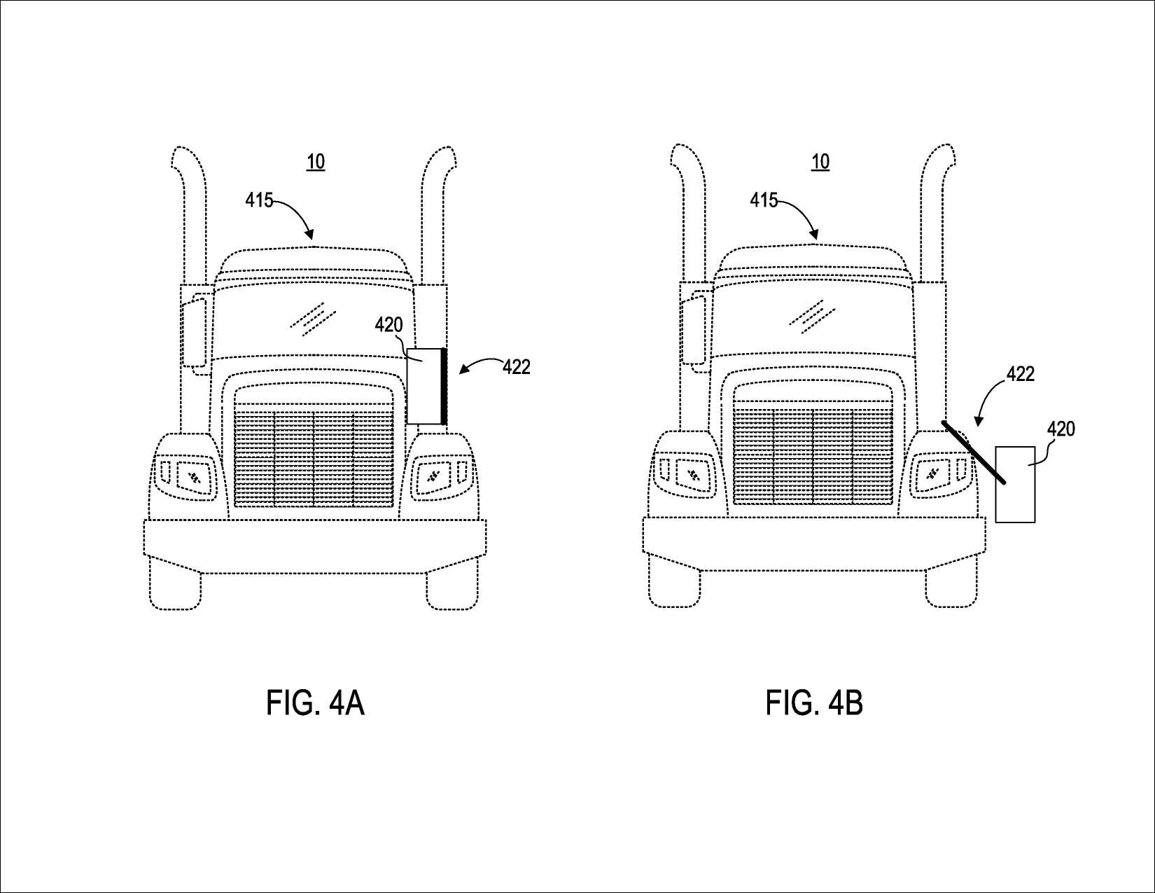

Turning now to FIGS. 4A-4B, another example vehicle 10, in accordance with aspects of the present disclosure, is illustrated. The vehicle 10 may include a vehicle cabin 415 for one or more occupant (e.g., a driver, passenger, and so forth). In some embodiments, the vehicle 10 may include a deployable utility unit 420 partially or completely housed inside the vehicle cabin 415, as shown. The deployable utility unit 420 may be supported and/or operated by a utility support system 422. The utility support system 422 may include various components, attachments, fasteners, mechanisms, and/or other features that may be used, alone or in combination with various components, attachments, fasteners and/or other features on the deployable utility unit 420, to hold the deployable utility unit 420 partially or completely inside the vehicle cabin 415, to advance or deploy the deployable utility unit 420 from the vehicle cabin 415 to an exterior position, to secure the deployable utility unit 420 in the exterior position, and/or to retract or stow the deployable utility unit 420.

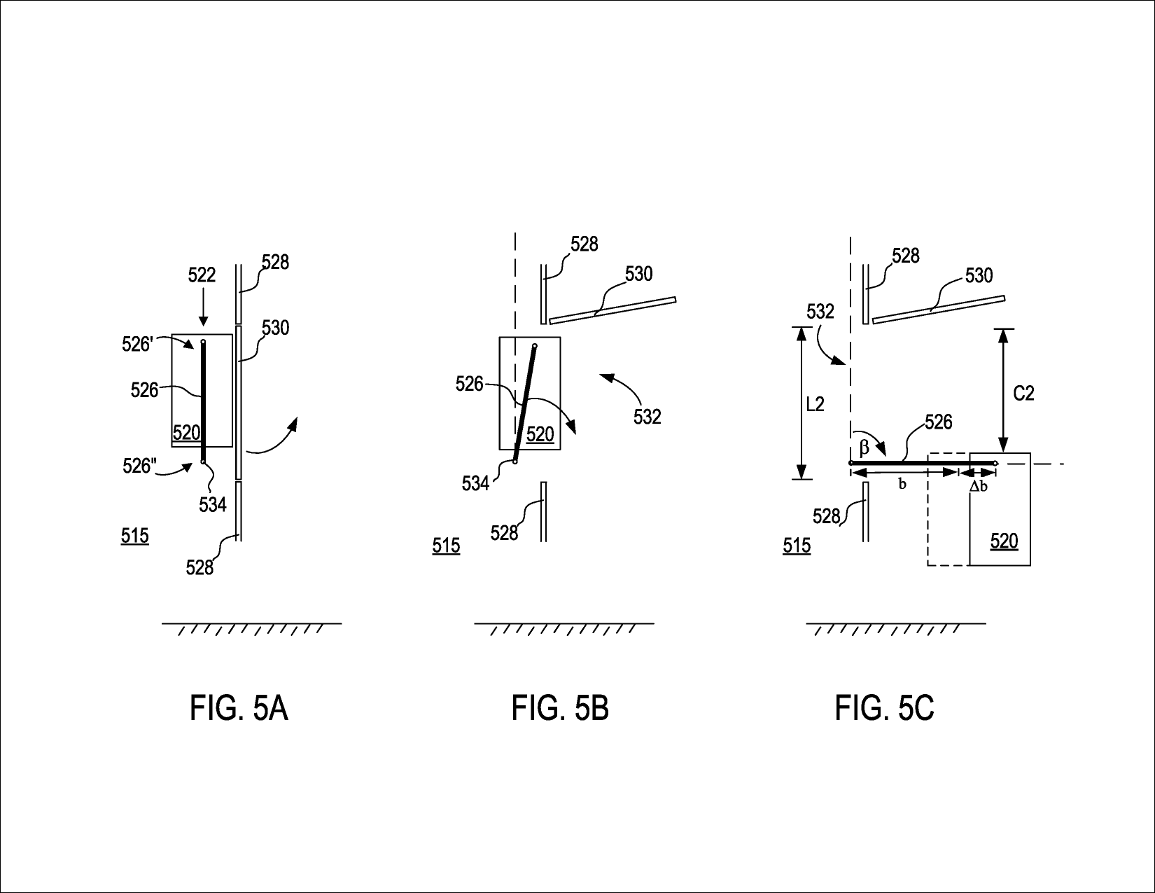

FIGS. 5A-5C illustrate one example of a utility support system 522 operating in cooperation with a deployable utility unit 520 partially or completely housed inside a vehicle cabin 515, in accordance with aspects of the present disclosure. In some embodiments, the utility support system 522 includes a utility support arm 526. While FIGS. 5A-5C show the utility support system 522 with one utility support arm 526, it may be appreciated that the utility support system 522 may include more than one utility support arm 526.

As shown in FIG. 5A, the utility support arm 526 may be connected or connectable to the deployable utility unit 520, as well as to the vehicle cabin 515. For instance, in some embodiments, a first end 526’ of the utility support arm 526 may be directly attached or attachable to a portion or component of the deployable utility unit 520, and a second end 526” of the utility support arm 526 may be directly attached or attachable to a portion or component of the vehicle cabin 515, such as a vehicle cabin interior (not shown) or a vehicle cabin exterior housing 528. In other embodiments, the first end 526’ of the utility support arm 526 may be indirectly attached or attachable to the portion or component of the deployable utility unit 520, for instance, by way of a component or object positioned in between the first end 526’ of the utility support arm 526 and the deployable utility unit 520. Similarly, in some embodiments, the second end 526” of the utility support arm 524 may be indirectly attached or attachable to the portion or component of the vehicle cab 515, for instance, by way of a component or object positioned in between the second end 526” of the utility support arm 526 and the vehicle cabin interior or the vehicle cabin exterior housing 528.

In some embodiments, the utility support arm 526 may be connected or connectable to the deployable utility unit 520 at the first end 526’ using a fastener, assembly, and/or mechanism that allows rotation of the utility support arm 526 relative to the deployable utility unit 520. In some embodiments, the utility support arm 526 may be connected to the deployable utility unit 520 at the second end 526” using a fastener, assembly, and/or mechanism that allows rotation of the utility support arm 526 relative to the vehicle cabin 515, or portion or component of the vehicle cabin 515. As shown in FIGS. 5A-5C, in some embodiments, a point of attachment of the first end 526’ and/or of the second end 526” of the utility support arm 526 on the deployable utility unit 520 may remain fixed during movement of the deployable utility unit 520.

The deployable utility unit 520 may be positioned exterior to the vehicle cabin 515 by operating a movable panel 530 covering an opening 532 in the vehicle cabin exterior housing 528. The movable panel 530 may cover the opening 532 in a manner sufficient or suitable to protect the vehicle cabin 515 interior from exterior elements, as well as risk to any object and/or occupant present in the vehicle cabin 515 interior during vehicle operation. For instance, in some embodiments, the movable panel 530, or a portion thereof, may make close contact (e.g., less than 10 mm) and/or seal to the vehicle cabin exterior housing 528 by virtue of, for example, a sealing layer or strip affixed to, on, or about a periphery of the movable panel 530 and/or opening 532 in the vehicle cabin exterior housing 528, as described.

In some embodiments, as shown in FIG. 5B, the movable panel 530 may be connected to and rotated about, for example, about a panel hinge to uncover the opening 532 in the vehicle cabin exterior housing 528. As described, the movable panel 530 may be pushed, pulled, and/or actuated upward, downward, outward, or to one side relative to the vehicle cabin 515. In some embodiments, the movable panel 530 may be detached from the vehicle cab exterior housing 528, for instance, by way of a quick release, or other fastener, assembly, or mechanism. The movable panel 530 may also be operable while the deployable utility unit 520 is deployed or in use. For instance, in some implementations, the movable panel 530 may be repositioned or reattached to cover the opening 532 in the vehicle cabin exterior housing 528 when the deployable utility unit 520 is in the second, deployed, position exterior to the vehicle cabin 515.

The deployable utility unit 520 may be advanced through the opening 532 by pivoting the utility support arm 526 about a pivot point or pivot axis 534 located at or about the second end 526” of the utility support arm 526, as shown in FIGS. 5A-5C. In this manner, the utility support arm 526 may rotate over an angle β relative to a vertical axis, where the angle β of rotation may be in a range between approximately 0 and 135 degrees, although other values may be possible. In one non-limiting example, illustrated in FIG. 5C, the utility support arm 526 of the deployable utility unit 520 may be rotated from an angle β of 0 degrees corresponding to a first, or stowed position, to angle β of approximately 90 degrees, or more, corresponding to a second, or deployed position, although other intermediate positions therebetween, as well as other positions may be possible.

The opening 532 in the vehicle cabin exterior housing 528 may have any shape and dimension suitable for allowing the deployable utility unit 520 to be advanced and retracted. In some embodiments, as illustrated in FIG. 5C, a vertical dimension L2 of the opening 532 may be such that upon advancement of the deployable utility unit 520 to a second, or deployed, position, a vertical clearance C2 would remain. In some applications, the vertical clearance C2 may provide an additional access point to an interior of the vehicle cabin 515.

The utility support arm 526 connected to the deployable utility unit 520 may be rigid, flexible, extendible, telescoping, articulating, actuating, foldable, windable, adjustable, pneumatic, powered, and so forth. As such, the utility support arm 526, or a component thereof, may extend, telescope, fold, wind or unwind, articulate, actuate, adjust, pressurize, power, and so forth. For example, the utility support arm 526 may move by pivoting about a point or axis of attachment on the vehicle cab 515 (e.g., on the vehicle cabin interior or vehicle cabin exterior housing 528) at the second end 526” of the utility support arm 526. Additionally, the utility support arm 526, or a component thereof, may transform in shape and/or configuration with movement of the deployable utility unit 520. For instance, the utility support arm 526 may transform in shape by expanding from a length b to a length b+Δb, as illustrated in FIG. 5C.

In one non-limiting example, the utility support arm 526 may include a spring that may expand or contract subject to mechanical force applied thereto. In another non-limiting example, the utility support arm 526 may include a telescoping arm that may expand or contract subject to mechanical and/or other force subject thereto. In yet another non-limiting example, the utility arm 526 may include cylinder and piston assembly that may expand or contract subject to air, gas, or liquid pressure applied to the cylinder and/or piston. In yet another non-limiting example, the utility support arm 526 may include a cable that may expand or contract subject to mechanical force applied thereto. In yet another non-limiting example, the utility support arm 526 may include a cable that may wind or unwind subject to mechanical, electrical, magnetic, or other force applied, for instance, to a gear, wench, or other component or mechanism.

In some embodiments, the deployable utility unit 520 may serve a protective function similar to the movable panel 530, and as such replace the movable panel 530, as described. Also, the deployable utility unit 520, the utility support arm 526, and/or movable panel 530 may be operated manually and/or with the assistance of various mechanisms, actuators, and so forth, as described. For instance, various movements and functions of the deployable utility unit 520, the utility support arm 526, and/or movable panel 530 may be controlled in whole or in part using a utility control module 116 according to FIG. 1A, for example.

In some embodiments, the deployable utility unit 520 may be detached from the utility support system 522 upon deployment. For instance, the deployable utility 520 may be advanced to the second, deployed, position and then detached from the utility support system 522. For example, the deployable utility unit 520 may be detached from the first end 526’ of the utility support arm 526 by way of a quick release, as well as other fastener, assembly, or mechanism.

In some implementations, the utility support arm 526 and/or deployable utility unit 20 may be operated, for instance, by way of movement and/or transformation, to allow the deployable utility unit 520 to reach or extend to a position convenient for an operator (e.g., vehicle operator, vehicle occupant, etc.). For example, the utility support arm 526 may be expanded to a length allowing the deployable utility unit 520 to reach or be placed on the ground.

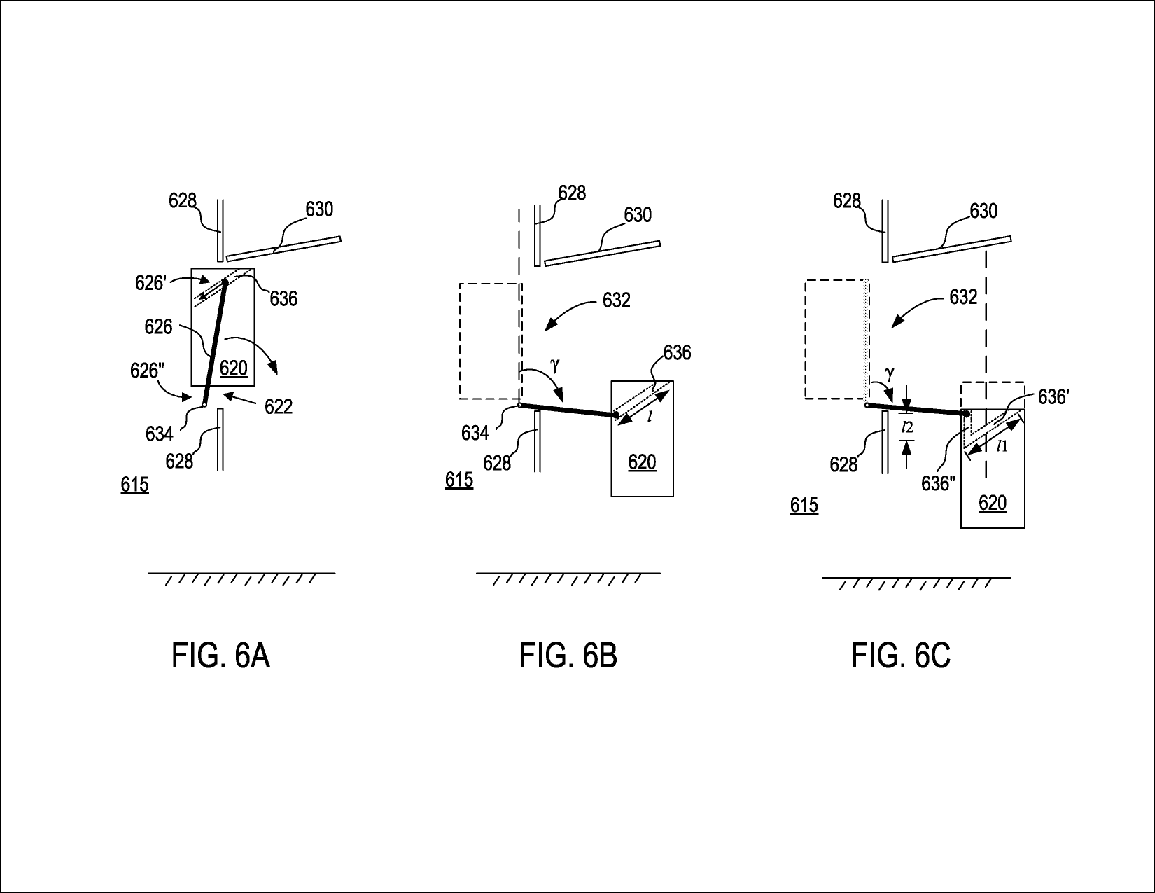

Turning now to FIGS. 6A-6C, another example utility support system 622 is illustrated operating in cooperation with a deployable utility unit 620 partially or completely housed inside a vehicle cabin 615, in accordance with aspects of the present disclosure. In some embodiments, the utility support system 622 includes a utility support arm 626. As illustrated in FIGS. 6A-6C, the utility support arm 626 may engage with a track 636 on the deployable utility unit 620 that allows for advancement and retraction of the deployable utility unit 620. While FIGS. 6A-6C show the utility support system 622 with one utility support arm 626, it may be appreciated that the utility support system 622 may include more than one utility support arm 626.

As shown in FIG. 6A, the utility support arm 626 may be movably connected or connectable to the deployable utility unit 620, as well as to the vehicle cabin 615. For instance, in some embodiments, a first end 626’ of the utility support arm 626 may be directly attached or attachable to a portion or component of the deployable utility unit 620, and a second end 626” of the utility support arm 626 may be directly attached or attachable to a portion or component of the vehicle cabin 615, such as a vehicle cabin interior (not shown) or a vehicle cabin exterior housing 628. In other embodiments, the first end 626’ of the utility support arm 626 may be indirectly attached or attachable to the portion or component of the deployable utility unit 620, for instance, by way of a component or object positioned in between the first end 626’ of the utility support arm 626 and the deployable utility unit 620. Similarly, in some embodiments, the second end 626” of the utility support arm 624 may be indirectly attached or attachable to the portion or component of the vehicle cab 615, for instance, by way of a component or object positioned in between the second end 626” of the utility support arm 626 and the vehicle cabin interior or the vehicle cabin exterior housing 628.

In some embodiments, the utility support arm 626 may be movably connected or connectable to the deployable utility unit 620 at the first end 626’ using a fastener, assembly, feature and/or mechanism that allows movement and/or rotation of the utility support arm 626 relative to the deployable utility unit 620. In some embodiments, the utility support arm 626 may be movably connected to the deployable utility unit 620 at the second end 626” using a fastener, assembly, and/or mechanism that allows rotation of the utility support arm 626 relative to the vehicle cabin 615, or portion or component of the vehicle cabin 615.

As shown in FIGS. 6A-6C, in some embodiments, a point of attachment of the second end 626” of the utility support arm 626 on the deployable utility unit 620 may remain fixed during movement of the deployable utility unit 620. In some embodiments, a point of attachment of the first end 626’ of the utility support arm 626 on the deployable utility unit 620 may vary during movement of the deployable utility unit 620.

The deployable utility unit 620 may be positioned exterior to the vehicle cabin 615 by operating a movable panel 630 covering an opening 632 in the vehicle cabin exterior housing 628. The movable panel 630 may cover the opening 632 in a manner sufficient or suitable to protect the vehicle cabin 615 interior from exterior elements, as well as risk to any object and/or occupant present in the vehicle cabin 615 interior during vehicle operation. For instance, in some embodiments, the movable panel 630, or a portion thereof, may make close contact (e.g., less than 10 mm) and/or seal to the vehicle cabin exterior housing 628 by virtue of, for example, a sealing layer or strip affixed to, on, or about a periphery of the movable panel 630 and/or opening 632 in the vehicle cabin exterior housing 628, as described.

In some embodiments, as shown in FIG. 6B, the movable panel 630 may be connected to and rotated about, for example, about a panel hinge to uncover the opening 632 in the vehicle cabin exterior housing 628. In other embodiments, as described, the movable panel 630 may be pushed, pulled, and/or actuated upward, downward, outward, or to one side relative to the vehicle cabin 615. As described, in some embodiments, the movable panel 630 may be detached from the vehicle cab exterior housing 628, for instance, by way of a quick release, or other fastener, assembly, or mechanism. The movable panel 630 may also be operable while the deployable utility unit 620 in use. For instance, the movable panel may be repositioned or reattached to cover the opening 632 while the deployable utility unit 620 is deployed.

The deployable utility unit 620 may be advanced through the opening 632 by pivoting the utility support arm 626 about a pivot point or pivot axis 634 located at or about the second end 626” of the utility support arm 626, as shown in FIG. 6B. In this manner, the utility support arm 626 may rotate over an angle γ relative to a vertical axis, where the angle γ of rotation may be in a range between approximately 0 and 135 degrees, although other values may be possible. In some implementations, a portion or component of the utility support arm 626 at the first end 626’ may move along the track 636 of the deployable utility unit 620 with rotation of the utility support arm 626. In one non-limiting example, illustrated in FIG. 6B, the utility support arm 626 of the deployable utility unit 620 may be rotated from an angle γ of 0 degrees corresponding to a first, or stowed position, to angle γ of approximately 90 degrees, or more, corresponding to a second, or deployed position, although other intermediate positions therebetween, as well as other positions may be possible. The portion or component of the utility support arm 626 at the first end 626’ may move a distance l along the track 636. In this example, the track is angled relative to a vertical axis. While movement of the portion or component of the utility support arm 626 at the first end 626’ along the track 636 may be coordinated with rotation of the utility support arm 626, the rotation and movement may be carried out separately.

The opening 632 in the vehicle cabin exterior housing 628 may have any shape and dimension suitable for allowing the deployable utility unit 620 to be advanced and retracted. In some embodiments, the opening 532 may be such that upon advancement of the deployable utility unit 620 to a second, or deployed, position, a vertical clearance would remain. In some applications, the vertical clearance may provide an additional access point to an interior of the vehicle cabin 615.

The utility support arm 626 may be rigid, flexible, extendible, telescoping, articulating, actuating, foldable, windable, adjustable, pneumatic, powered, and so forth. As such, the utility support arm 626, or a component thereof, may extend, telescope, fold, wind or unwind, articulate, actuate, adjust, pressurize, power, and so forth. For example, the utility support arm 626 may move by pivoting about a point or axis of attachment 634 on the vehicle cab 615 (e.g., on the vehicle cabin interior or vehicle cabin exterior housing 628) at the second end 626” of the utility support arm 626. Additionally, the utility support arm 626, or a component thereof, may transform in shape and/or configuration with movement of the deployable utility unit 620. For instance, the utility support arm 626 may transform in shape by expanding and contracting, as described.

In one non-limiting example, the utility support arm 626 may include a spring that may expand or contract subject to mechanical force applied thereto. In another non-limiting example, the utility support arm 626 may include a telescoping arm that may expand or contract subject to mechanical and/or other force subject thereto. In yet another non-limiting example, the utility arm 626 may include cylinder and piston assembly that may expand or contract subject to air, gas, or liquid pressure applied to the cylinder and/or piston. In yet another non-limiting example, the utility support arm 626 may include a cable that may expand or contract subject to mechanical force applied thereto. In yet another non-limiting example, the utility support arm 626 may include a cable that may wind or unwind subject to mechanical, electrical, magnetic, or other force applied, for instance, to a gear, wench, or other component or mechanism.

As described, the deployable utility unit 620 may serve a protective function similar to the movable panel 630, and as such replace the movable panel 630. Also, the deployable utility unit 620, the utility support arm 626, and/or movable panel 630 may be operated manually and/or with the assistance of various mechanisms, actuators, and so forth, as described. For instance, various movements and functions of the deployable utility unit 620, the utility support arm 626, and/or movable panel 630 may be controlled in whole or in part using a utility control module 116 according to FIG. 1A, for example.

As described, in some embodiments, the deployable utility unit 620 may be detached from the utility support system 622 upon deployment. For instance, the deployable utility 620 may be advanced to the second, deployed, position and then detached from the utility support system 622. For example, the deployable utility unit 620 may be detached from the first end 626’ of the utility support arm 626 by way of a quick release, as well as other fastener, assembly, or mechanism.

In some embodiments, the track 636 of the deployable utility unit 630 may allow for a more complex movement of the deployable utility unit 630. Referring particularly to FIG. 6C, in some embodiments, the track 636 may include a first track portion 636’ having a length l1 and a second track portion 636” having a length l2, where the first track portion 636’ is angled relative to a vertical axis while the second track portion 636” is parallel to the vertical axis. As appreciated from FIG. 6C, such configuration of the track 636 allows for advancement of the deployable utility unit 630 exterior to the vehicle cabin 615 as well as lowering the deployable utility unit 630 an additional vertical distance corresponding to the length l2 of the second track portion 636”. In some examples, the additional vertical distance may provide for better accessibility, convenience, and/or securing the deployable utility unit 603 in a second, deployed, position, for instance.

As described, in some implementations, the utility support arm 626 and/or deployable utility unit 620 may be operated to allow the deployable utility unit 620 to reach or extend to a position convenient for an operator. For example, the length l1 of the first track portion 636’ and/or the length l2 of the second track portion 636” may be configured to allow the deployable utility unit 620 to reach or be placed on the ground.

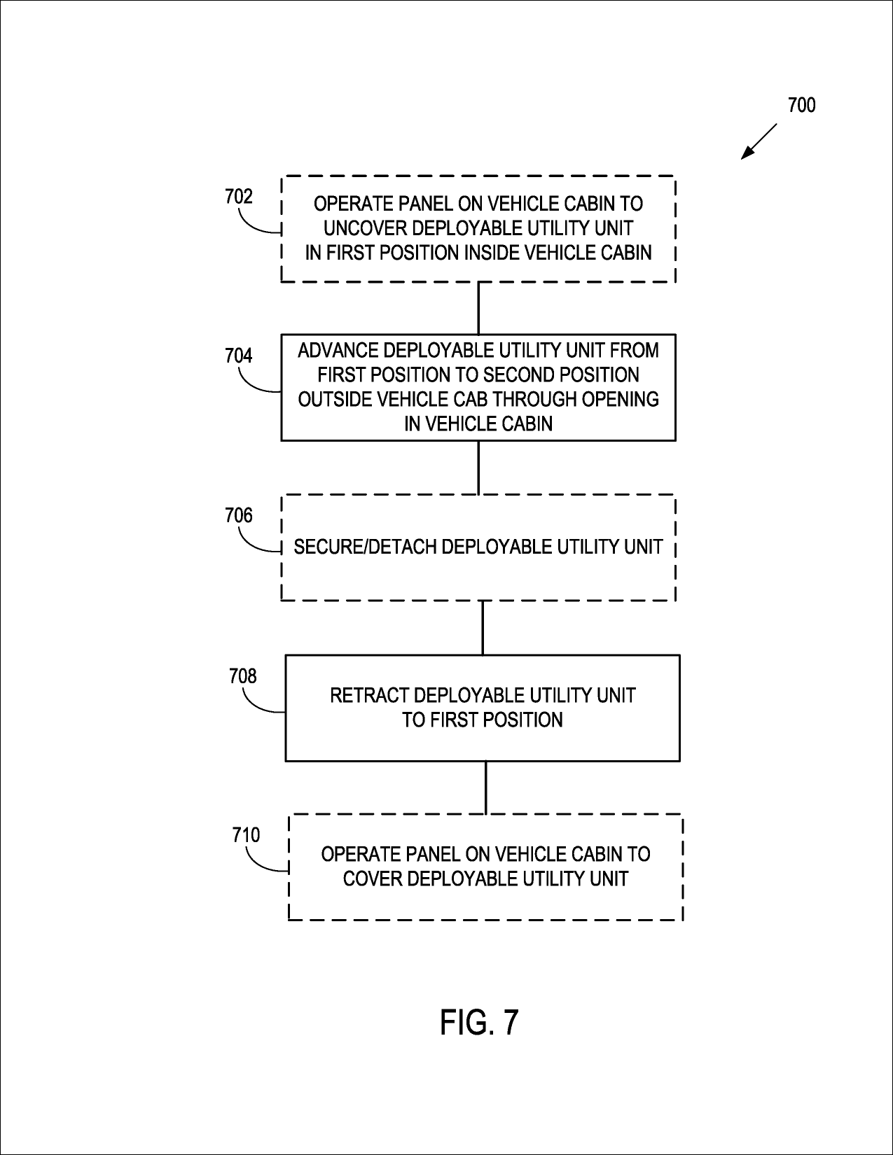

Turning now to FIG. 7 a flowchart setting forth steps of a process 700, in accordance with aspects of the present disclosure, is illustrated. Steps of the process 700 may be carried out using any combination of suitable devices or systems, as well as using systems described in the present disclosure. In some embodiments, steps of the process 700 may be implemented as instructions stored in non-transitory computer readable media, as a program, firmware or software, and executed by a general-purpose, programmed or programmable, computer, processor, or any other computing device. In other embodiments, steps of the process 700 may be hardwired in an application-specific computer, processer, or dedicated system or module as described with reference to FIG. 1A. Although the process 700 is illustrated and described as a sequence of steps, it is contemplated that the steps may be performed in any order or combination. The process 700 need not include all of the illustrated steps, and in some implementations may include other or additional steps.

The process 700 may optionally begin at process block 702 by operating a movable panel on a vehicle cabin to uncover a deployable utility unit inside the vehicle cabin positioned in a first position (e.g., stowed position), for instance, as described with reference to FIGS. 1B-6C. The deployable utility unit may then be advanced from the first position to a second position (e.g., deployed position) exterior to, or outside, the vehicle cabin through an opening in the vehicle cabin, as indicated by process block 704.

The process 700 may optionally continue at process block 706 by securing and/or detaching the deployable utility unit. In some implementations, process block 706 may include steps for engaging or activating a locking mechanism, a safety feature, and so forth, to secure the deployable utility unit (e.g., in the second position). In other implementations, process block 706 may include steps for operating a quick release, or other fastener, assembly, or mechanism to detach the deployable utility unit from a utility support system. In yet other implementations, process block 706 may include steps for moving the deployable utility unit, as described with reference to FIGS. 6B-6C. For example, the deployable utility unit may be moved along a track and/or lowered to the ground. In yet other implementations, process block 706 may include steps for operating the movable panel to reposition and/or reattach the movable panel to cover the opening in the vehicle cabin exterior housing when the deployable utility unit is in the second position, or in use. In yet other implementations, process block 706 may include a combination of steps, as described above.

Deployment of the deployable utility unit may then be reversed. To this end, various steps described with reference to process blocks 702 and 704, in any combination, may be carried in reverse order. For instance, in some implementations, the deployable utility unit may be retracted to the first position, as indicated by process block 708. In other implementations, the movable panel on the vehicle cabin may be repositioned or reattached uncover the opening in the vehicle cabin allowing retraction of the deployable utility unit. In yet other implementations, movement of the deployable utility unit along a track may be carried out, as described. In yet other implementations, the deployable utility unit may be attached to the utility support system. The movable panel may then be optionally operated to cover the deployable utility unit, as indicated by process block 710.

One or more steps of the process 700 may be carried out manually and/or automatically, for instance, by controlling various movements and functions the movable panel, and/or deployable utility unit, in whole or in part, using a utility control module 116 according to FIG. 1A, for example. To control movement and function, various forces may be generated and/or applied, as well as various steps may be taken to regulate fluid flow, regulate gas flow, regulate air flow, move and/or energize components, and so forth, to control one or more valve or relay, operate one or more gear, switch, motor, crank, pulley, winch, and so forth, by way of mechanical, hydraulic, pneumatic, magnetic or electrical activation, or movement of components.

In some implementations, a report may be generated and provided at one or more of steps of the process 700. The report may be in any form, and include various data and information, including various visual and/or audio signals, images, graphics, tabulated information, data, instructions (user-readable or machine-readable), graphs, lists, numbers, text, and so forth. For example, the report may indicate whether a deployable utility unit, or a component thereof, is in a first position (e.g., stowed partially or completely inside the vehicle cabin), in a second position (e.g., deployed external to the vehicle 10), or in an intermediate position between the first position and the second position. The report may also indicate an error, or malfunction in the deployable utility unit, movable panel, or component thereof. The report may be communicated by way of a display, touchscreen, navigation system, speaker, and other outputs on a vehicle, as well as transmitted to various devices, systems, or third parties.

One or more steps of the process 700 may be carried out subject to input or instruction from an operator (e.g., vehicle operator), and/or one or more computer, system, device, or component on a vehicle. To this end, various signals, data, and/or information may be received, accessed, and/or processed. For example, as described with reference to FIG. 1A, various signals, data, and/or information may be acquired using one or more device, component, or sensor disposed on or about a vehicle. A utility control module may then act upon such signals, data, and/or information, to control a deployable utility unit, or one or more component thereof. For example, in some implementations, the utility control module may receive an operator instruction (e.g., via an input element) to deploy or stow a deployable utility unit, or one or more component thereof. To this end, the utility control module may generate and transmit various control signals. For example, one or more control signal (e.g., in the form of voltage signals, current signals, optical signals, and so forth) may control a solenoid, winch, motor, valve, crank, pulley, gear, relay, switch, air pressure, liquid pressure, gas pressure, power, and so forth. In other embodiments, the utility control module 116 may utilize received, accessed, and/or processed signals, data, and/or information to determine a status or position of the deployable utility unit 20, or a component thereof.

According to one embodiment, a vehicle is provided. The vehicle comprises a vehicle cabin for one or more occupant, and a deployable utility unit housed partially or completely in the vehicle cabin, and connected to the vehicle cabin using a support mechanism comprising at least one hinge and at least one utility support arm each attached to the deployable utility unit, wherein the deployable utility unit is advanced from a first position inside the vehicle cabin to a second position exterior to the vehicle cabin by pivoting the deployable utility unit about the at least one hinge through an opening in a vehicle cabin exterior housing. In one embodiment, the deployable utility unit comprises a deployable kitchen unit comprising cooking equipment. In another embodiment, a first part of the at least one utility hinge is attached or attachable to the deployable utility unit, and a second part of the utility hinge is attached or attachable to the vehicle cabin. In yet another embodiment, a first end of the at least one utility support arm is attached or attachable to the deployable utility unit, and a second end of the at least one utility support arm is attached or attachable to the vehicle cabin. In yet another embodiment, the at least one utility support arm transforms in shape, configuration, or both, with movement of the deployable utility unit from the first position to the second position. In yet another embodiment, the at least one support arm further comprises a rod, a cable, a spring, a chain, a telescoping arm, a link, a jib, a crane, a cylinder, or a combination thereof, attached or attachable to at least one attachment point on the deployable utility unit. In yet another embodiment, the vehicle cabin further comprises a movable panel covering the opening in a vehicle cabin exterior housing. In yet another embodiment, the movable panel is operable to cover the opening in the vehicle cabin exterior housing when the deployable utility unit is in the second position exterior to the vehicle cabin.

According to one embodiment, a vehicle is provided. The vehicle comprises a vehicle cabin for one or more occupant, and a deployable utility unit housed partially or completely in the vehicle cabin, and connected to the vehicle cabin using a support mechanism comprising at least one utility support arm attached to the deployable utility unit, wherein the deployable utility unit is advanced from a first position inside the vehicle cabin to a second position exterior to the vehicle cabin by pivoting the at least one utility support arm through an opening in a vehicle cabin exterior housing. In one embodiment, a first end of the at least one utility support arm is attached or attachable to the deployable utility unit, and a second end of the at least one utility support arm is attached or attachable to the vehicle cabin. In another embodiment, the at least one utility support arm transforms in shape, configuration, or both, with movement of the deployable utility unit from the first position to the second position. In yet another embodiment, the at least one support arm further comprises a rod, a cable, a spring, a chain, a telescoping arm, a link, a jib, a crane, a cylinder, or a combination thereof, attached or attachable to at least one attachment point on the deployable utility unit. In yet another embodiment, the vehicle cabin further comprises a movable panel covering the opening in a vehicle cabin exterior housing, wherein the movable panel is operable to cover the opening in the vehicle cabin exterior housing when the deployable utility unit is in the second position exterior to the vehicle cabin. In yet another embodiment, the deployable utility unit further comprises at least one track that engages with the at least one support arm to advance and retract the deployable utility unit. In yet another embodiment, the at least one track further comprises a first track portion having a first length and a second track portion having a second length, wherein the first track portion is angled relative to a vertical axis and the second track portion is parallel to the vertical axis.

While the present disclosure has described a number of embodiments and implementations, the disclosure is not so limited but covers various obvious modifications and equivalent arrangements, which fall within the purview of the appended claims. Although certain features are expressed in certain combinations among the claims, it is contemplated that these features can be arranged in any combination and order. It should be appreciated that many equivalents, alternatives, variations, and modifications, aside from those expressly stated, are possible.

1. A vehicle comprising:
a vehicle cabin for one or more occupant; and
a deployable utility unit housed partially or completely in the vehicle cabin, and connected to the vehicle cabin using a support mechanism comprising at least one hinge and at least one utility support arm each attached to the deployable utility unit,
wherein the deployable utility unit is advanced from a first position inside the vehicle cabin to a second position exterior to the vehicle cabin by pivoting the deployable utility unit about the at least one hinge through an opening in a vehicle cabin exterior housing.

2. The vehicle of claim 1, wherein the deployable utility unit comprises a deployable kitchen unit comprising cooking equipment.

3. The vehicle of claim 1, wherein a first part of the at least one utility hinge is attached or attachable to the deployable utility unit, and a second part of the utility hinge is attached or attachable to the vehicle cabin.

4. The vehicle of claim 1, wherein a first end of the at least one utility support arm is attached or attachable to the deployable utility unit, and a second end of the at least one utility support arm is attached or attachable to the vehicle cabin.

5. The vehicle of claim 4, wherein the at least one utility support arm transforms in shape, configuration, or both, with movement of the deployable utility unit from the first position to the second position.

6. The vehicle of claim 4, wherein the at least one support arm further comprises a rod, a cable, a spring, a chain, a telescoping arm, a link, a jib, a crane, a cylinder, or a combination thereof, attached or attachable to at least one attachment point on the deployable utility unit.

7. The vehicle of claim 1, wherein the vehicle cabin further comprises a movable panel covering the opening in a vehicle cabin exterior housing.

8. The vehicle of claim 7, wherein the movable panel is operable to cover the opening in the vehicle cabin exterior housing when the deployable utility unit is in the second position exterior to the vehicle cabin.

9. A vehicle comprising:
a vehicle cabin for one or more occupant; and
a deployable utility unit housed partially or completely in the vehicle cabin, and connected to the vehicle cabin using a support mechanism comprising at least one utility support arm attached to the deployable utility unit,
wherein the deployable utility unit is advanced from a first position inside the vehicle cabin to a second position exterior to the vehicle cabin by pivoting the at least one utility support arm through an opening in a vehicle cabin exterior housing.

10. The vehicle of claim 9, wherein a first end of the at least one utility support arm is attached or attachable to the deployable utility unit, and a second end of the at least one utility support arm is attached or attachable to the vehicle cabin.

11. The vehicle of claim 10, wherein the at least one utility support arm transforms in shape, configuration, or both, with movement of the deployable utility unit from the first position to the second position.

12. The vehicle of claim 10, wherein the at least one support arm further comprises a rod, a cable, a spring, a chain, a telescoping arm, a link, a jib, a crane, a cylinder, or a combination thereof, attached or attachable to at least one attachment point on the deployable utility unit.

13. The vehicle of claim 9, wherein the vehicle cabin further comprises a movable panel covering the opening in a vehicle cabin exterior housing, wherein the movable panel is operable to cover the opening in the vehicle cabin exterior housing when the deployable utility unit is in the second position exterior to the vehicle cabin.

14. The vehicle of claim 9, wherein the deployable utility unit further comprises at least one track that engages with the at least one support arm to advance and retract the deployable utility unit.

15. The vehicle of claim 14, wherein the at least one track further comprises a first track portion having a first length and a second track portion having a second length, wherein the first track portion is angled relative to a vertical axis and the second track portion is parallel to the vertical axis.
